(19) United States
(12) Patent Application Publication
(10) Pub. No.: US 2015/0044519 A1
(43) Pub. Date: Feb. 12, 2015

(54) BATTERY PACK THERMAL MANAGEMENT SYSTEM

(71) Applicant: Husqvarna AB, Huskvarna (SE)

(72) Inventors: Joachim Rief, Biberach (DE); Tobias Zeller, Neu-Ulm (DE)

(73) Assignee: Husqvarna AB, Huskvarna (SE)

(21) Appl. No.: 14/385,538

(22) PCT Filed: Nov. 23, 2012
(86) PCT No.: PCT/EP2012/073444

§ 371 Date: Sep. 16, 2014

(30) Foreign Application Priority Data
Mar. 19, 2012 (EP) 2012/054847
Mar. 19, 2012 (EP) 2012054846

(51) Int. Cl. H01M 10/613; H01M 10/6235; H01M 10/643; H01M 2/10

(52) U.S. Cl. CPC H01M 10/5004; H01M 2/105; H01M 10/5014; H01M 10/503; H01M 2220/30
USPC 429/50; 429/71; 429/120

(57) ABSTRACT

A battery pack may include a cell housing configured to retain a plurality of battery cells, and a plurality of cell reception slots within the cell housing to receive respective ones of the battery cells. The cell reception slots may be configured within the cell housing to define at least one fluid flow channel extending substantially in a first direction through the cell housing. The fluid flow channel may be defined at least partially by a rib connecting at least two adjacent cell reception slots to enable thermal transfer from cells disposed in the at least two adjacent cell reception slots responsive to movement of a fluid through the fluid flow channel and to inhibit a crossflow of fluid between the at least two adjacent cell reception slots in a direction other than the first direction.

### TECHNICAL FIELD

Example embodiments generally relate to battery pack technology and, more particularly, relate to mechanisms for thermal management within a battery pack.

### BACKGROUND

Property maintenance tasks are commonly performed using various tools and/or machines that are configured for the performance of corresponding specific tasks. Certain tasks, like cutting trees, trimming vegetation, blowing debris and the like, are typically performed by hand-held tools or power equipment. The hand-held power equipment may often be powered by gas or electric motors. Until the advent of battery powered electric tools, gas powered motors were often preferred by operators that desired, or required, a great deal of mobility. Accordingly, many walk-behind or ride-on outdoor power equipment devices, such as lawn mowers, are often powered by gas motors because they are typically required to operate over a relatively large range. However, as battery technology continues to improve, the robustness of battery powered equipment has also improved and such devices have increased in popularity.

The batteries employed in hand-held power equipment may, in some cases, be removable and/or rechargeable assemblies of a plurality of smaller cells that are arranged together in order to achieve desired output characteristics. However, charging and discharging battery cells causes heat production due to the internal resistance (impedance) of the cells. Therefore, when these cells are arranged together to form a battery pack, it is important to manage the thermal characteristics of the battery pack. Failure to properly manage to do can result in decreased battery performance or total failure of the battery pack. Furthermore, when used with handheld tools or outdoor power equipment, the battery packs may be operated in harsh or at least relatively uncontrolled conditions. Exposure to extreme temperatures, dust/debris, moisture and other conditions can present challenges for maintaining performance and/or integrity of battery packs.

Therefore, to increase the robustness of battery packs that may be used in relatively inhospitable environments, and to improve the capacity of such battery packs to handle heat loads generated during a strong discharge, an improved battery pack and associated thermal management system is needed.

### BRIEF SUMMARY OF SOME EXAMPLES

Battery cells generate electricity via electrochemical reactions that may generate heat. Thus, sealing of battery packs, while useful in preventing exposure to some harsh conditions, may cause cell heat to be contained so that it builds up and is difficult to dissipate effectively. This may inadvertently create high internal temperatures that could damage cells or negatively impact cell performance. Some example embodiments may provide a battery pack provided with an airflow generation unit to cool cells of the battery pack. In this regard, some embodiments may provide for fixation of cells within a battery pack, but further provide for efficient air flow through the battery pack. Furthermore, in some embodiments, the cells may be held by a cell retainer that is structured to optimize air flow through the battery pack. The operating life of devices and their batteries, when such an airflow generation unit and corresponding cell retainer are employed, may therefore be increased and the overall performance of such a device may be improved.

In one example embodiment, a battery pack is provided. The battery pack may include a cell housing configured to retain a plurality of battery cells, and a plurality of cell reception slots within the cell housing to receive respective ones of the battery cells. The cell reception slots may be configured within the cell housing to define at least one fluid flow channel extending substantially in a first direction through the cell housing. The fluid flow channel may be defined at least partially by a rib connecting at least two adjacent cell reception slots to enable thermal transfer from cells disposed in the at least two adjacent cell reception slots responsive to movement of a fluid through the fluid flow channel and to inhibit a cross-flow of fluid between the at least two adjacent cell reception slots in a direction other than the first direction.

In another example embodiment, a battery powered, outdoor power equipment device is provided. The device may include a battery pack including a plurality of battery cells, a cell retainer assembly including a cell housing configured to retain the battery cells, and a plurality of cell reception slots within the cell housing to receive respective ones of the battery cells. The cell reception slots may be configured within the cell housing to define at least one fluid flow channel extending substantially in a first direction through the cell housing. The fluid flow channel may be defined at least partially by a rib connecting at least two adjacent cell reception slots to enable thermal transfer from cells disposed in the at least two adjacent cell reception slots responsive to movement of a fluid through the fluid flow channel and to inhibit a cross-flow of fluid between the at least two adjacent cell reception slots in a direction other than the first direction.

In another example embodiment, a method of cooling a battery pack is provided. The method may include providing the plurality of cells. The method may further include providing a cell housing configured to retain a plurality of battery cells, and forming a plurality of cell reception slots within the cell housing to receive respective ones of the battery cells. The cell reception slots may be configured within the cell housing to define at least one fluid flow channel extending substantially in a first direction through the cell housing. The fluid flow channel may be defined at least partially by a rib connecting at least two adjacent cell reception slots to enable thermal transfer from cells disposed in the at least two adjacent cell reception slots responsive to movement of a fluid through the fluid flow channel and to inhibit a cross-flow of fluid between the at least two adjacent cell reception slots in a direction other than the first direction.

Some example embodiments may improve the performance and/or the efficacy of battery powered equipment.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A illustrates a top perspective view of a portion of a battery pack according to an example embodiment;

FIG. 1B illustrates an exploded perspective view of a portion of a battery pack according to an example embodiment,

FIG. 2A illustrates a top view of the battery pack with a top part removed in order to reveal the inner structure of a cell retainer assembly of an example embodiment shown with battery cells disposed within cell reception slots;

FIG. 2B illustrates a top view of the battery pack with a top part removed in order to reveal the inner structure of the cell retainer assembly of an example embodiment shown with battery cells removed from cell reception slots;

FIG. 2C illustrates a top view of a battery pack with a top part removed in order to reveal the inner structure of a cell retainer assembly of an alternative example embodiment;

FIG. 3 shows an embodiment where airflow channels are formed that have a slightly wavy shape as airflow passes through the cell housing portion according to an example embodiment;

FIG. 4 illustrates a the battery pack incorporated into a backpack in accordance with an example embodiment;

FIG. 5 illustrates a partially exploded view of the backpack battery pack according to an example embodiment; and

FIG. 6 illustrates a method of thermally managing a battery pack in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection or interaction of components that are operably coupled to each other.

Some example embodiments may provide for a battery pack that can be useful in connection with battery powered tools or battery powered outdoor power equipment. Outdoor power equipment that is battery powered, and battery powered tools generally, typically include battery packs that include a plurality of individual cells. In order to achieve sufficient power, cells are organized and interconnected (e.g., in a series of series and/or parallel connections) to group the cells within a battery pack in a manner that achieves desired characteristics. The battery pack may be inserted into an aperture of the piece of equipment it powers so that the corresponding piece of equipment (e.g., hand-held, ride-on, or walk-behind equipment) is enabled to be mobile. However, in some cases, the battery pack may be inserted into a backpack or other carrying implement that the equipment operator may wear.

The cells of the battery pack are often rechargeable, cylindrical shaped cells. However, cells with other shapes, and even replaceable batteries could alternatively be employed in other embodiments. Given that the batteries produce energy via electrochemical reactions that generate heat, the battery pack may tend to heat up during charging or discharging operations. In particular, when the equipment operated by the battery pack is working hard, the discharge rates may be high. High capacity cells also tend to have high internal resistances. Accordingly, since power is equal to the square of current times resistance, it is clear that a high discharge rate will cause high power dissipation, and therefore high temperatures. Likewise, fast charging of the battery pack can also produce high temperatures. Given that cells are typically designed to operate within defined temperature ranges (e.g., −10° C. to +65° C.), temperature increases should be maintained at relatively low levels. If heat generation is excessive, temperatures may reach extreme levels at which cell damage may occur.

The cells may be held in place by a cell retainer. In some cases active cooling of the cells may be undertaken by forcing a cooling fluid (e.g., air) through the cell retainer (e.g., with a fan or pump) to carry heat away from the cells. However, the cells may be disposed in a pattern such that they are spaced apart from one another to form columns and rows, or some other distributed arrangements. When the cooling fluid is forced into one end of the cell retainer, the flow path around the cells may become very confused and turbulent due to the potential for numerous cross-flow paths between cells. This degradation of air flow may make it particularly difficult to ensure consistent cooling of cells throughout the battery pack.

Accordingly, some example embodiments may provide for a cell retainer structure that provides better and/or more evenly distributed cooling of the cells of the battery pack. In this regard, some example embodiments may close the spacing between selected cells so that defined fluid flow channels (e.g., airflow channels) may be created to provide a more even, consistent, predictable, and/or coherent flow of air past the cells to carry heat away from the cells. This may prevent excessively high temperatures that could cause thermal damage to cells or lead to thermal runaway. Better cell cooling may also cause cells to age more slowly and to lose their charge capacities more slowly. Prevention of overheating may also improve the operator experience since high temperature protective shutdowns of equipment may be avoided.

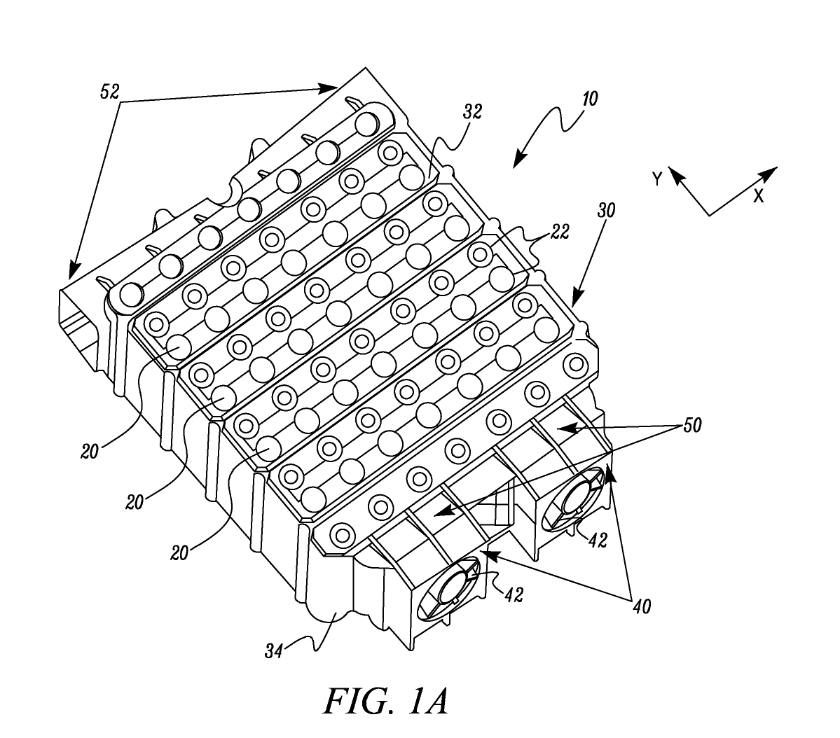

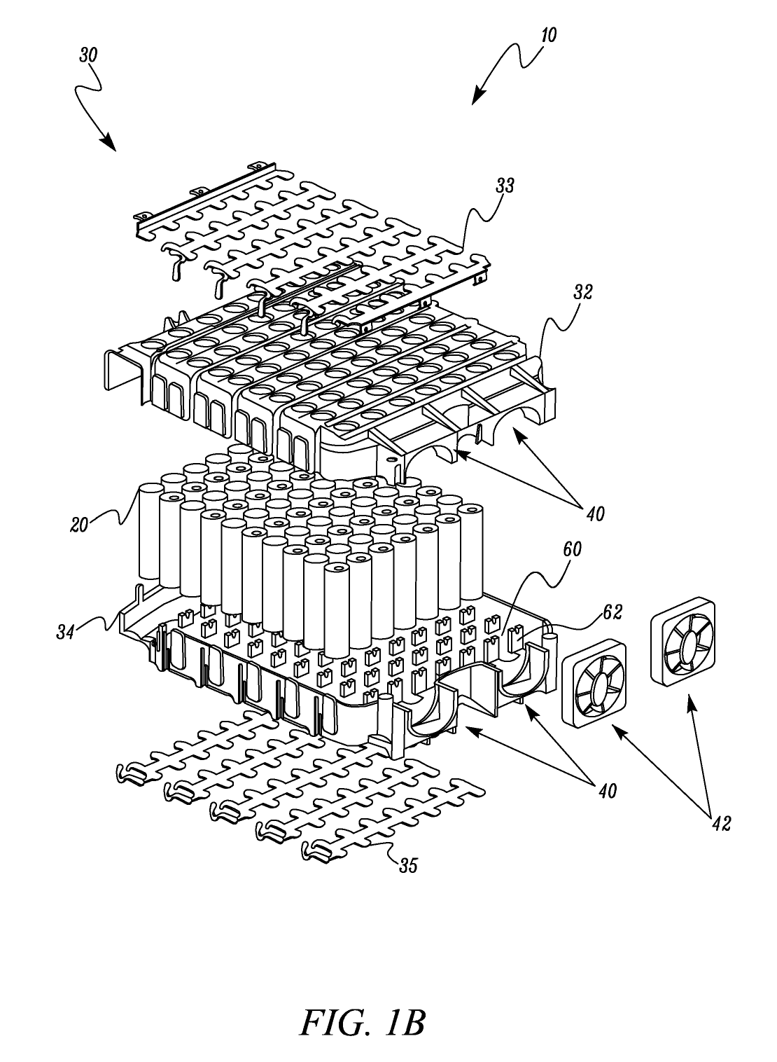

FIG. 1A illustrates one example of a top perspective view of a portion of a battery pack 10. FIG. 1B provides an exploded perspective of the battery pack 10. The battery pack 10 includes a plurality of individual cells 20 disposed within a cell retainer assembly 30. The cell retainer assembly 30 may include a plurality of cell reception slots into which the cells may be disposed and retained. The cell reception slots may be configured to conform to the size and shape of the cells 20 so that the cells 20 may be fixed in place within the cell retainer assembly 30. The cell retainer assembly 30 may further accommodate cell connection circuitry and/or electrodes (e.g., conductors, wires, and/or bars) that may be used to connect cells in series, parallel and/or combinations thereof to achieve the electrical characteristics desired for the battery pack 10.

Each of the cells 20 may be any suitable type of battery cell. For example, the cells 20 may be nickel-metal hydride (NiMH), nickel-cadmium (NiCd), lithium-ion (LIB), or other similar cells. Thus, in some cases, nominal cell voltages may range from about 1V to about 4V. Series connection of multiple cells may be used to increase the voltage rating of the group of connected cells, and parallel connection of multiple cells may be used to increase the power capacity of the battery pack.

In this example, the cell retainer assembly 30 may include a top part 32 and a bottom part 34, each of which may be molded to fit together to contain the cells 20. As such, for example, the top part 32 and the bottom part 34 may each be separately molded such that the cells 20 may be disposed within the bottom part 34 in corresponding cell reception slots formed within the bottom part 34. The top part 32 may then be snapped, screwed, welded or otherwise held in connection with the bottom part 34 in order to form the cell retainer assembly 30 in its assembled form.

As illustrated by the figures, in some embodiments the side walls of the cell retainer assembly 30 have a height slightly greater than the length of a cell 20. Furthermore, the top and bottom walls at least partially cover the ends of each cell 20 so that, when the top part 32 and bottom part 34 are attached together, the cells 20 are contained and held within the cell retainer assembly 30.

The top part 32 and bottom part 34 may each include respective electrodes for providing the series and/or parallel connection of the cells 20. In the illustrated battery pack 10, the top part 32 and the bottom part 34 of the cell retainer assembly 30 both include connection holes 22 through which electrical connections can be made with the cells 20 that are contained within the cell retainer assembly 30. Specifically, the cell retainer assembly is configured so that there is one connection hole 22 at the end of each cell retention slot so that an electrical connection can be made to the positive and negative terminals on opposing ends of each cell. In the illustrated embodiment, the connection holes 22 are round and each have a diameter at least somewhat smaller than the diameter of a cell 20 so that the cells cannot move through the connection holes 22 and, in some embodiments, so that air flowing through the cell retainer assembly 30 cannot easily escape between the cell 20 and its corresponding connection holes 22.

In the illustrated embodiment, the battery pack 10 includes seventy cells disposed in a common plane with the longitudinal axis of each cell parallel to the longitudinal axis of each other cell. The cells have generally uniform spacing so as to create a substantially rectangular arrangement of cells. Specifically, groups of ten cells are electrically connected in series in each column of cells 20 along the y-direction, and groups of seven cells are electrically connected in parallel in each row of cells 20 along the x-direction. In other words, the battery pack comprises ten rows of cells with nine cells in each row or, said another way, seven columns of cells with ten cells in each column. The series connected columns are electrically connected to each other in parallel by electrical connectors that connect the cells in each row in parallel. In the illustrated embodiment, the cells in each column have alternating polarities and the cells in each row have uniform polarities so that one connector can at the same time connect a row of cells in parallel and pairs of cells from adjacent rows in series. However, it will be appreciated that any desirable electrical connection may be employed and any arrangement may be employed in terms of the number of cells in the battery pack 10 and the physical and electrical organization of the cells therein. It should also be appreciated that in some cases, multiple cell packs could be housed within a single cell retainer. The cell packs may then be connected via fuses, switches or other connectors in any desirable manner. Moreover, in some cases, some cell packs may be utilized only under certain circumstances.

As shown in FIGS. 1A and 1B, the cell retainer assembly 30 may include at least one fan housing 40 disposed at one end of the cell retainer assembly 30. In this embodiment, the fan housing 40 may be integrally formed within the cell retainer assembly 30. Moreover, since the cell retainer assembly 30 may be formed of the top part 32 and the bottom part 34, a top portion of the fan housing 40 may be integrally formed in the top part 32, while a bottom part of the fan housing 40 may be integrally formed in the bottom part 34. A fan 42 may be disposed in each fan housing 40 that is provided in the cell retainer assembly 30. Specifically, in the illustrated embodiment, the fans 42 have a square exterior and the fan housing 40 comprises a corresponding square shape slightly larger than that of the fans 42. The fan housing 40 has two walls spaced apart a distance slightly larger than the width of a fan 42 so that the walls created a cradle between which a fan 42 can be placed. These walls of the fan housing 40 overlap a portion of the fan assembly to hold the fan 42 in place in the cell retainer assembly 30, but form a circle through which air can travel to and from the fan 42. In this way, assembly of the fans in the cell retainer may be made easy. In some embodiments, the fan housing 40 may include a seal, gasket, or resilient member around the perimeter so that air only flows by the fan blades and not between the fan 42 and the fan housing 40. It should be appreciated that although two fan housings and two fans are shown in FIGS. 1A and 1B, alternative embodiments may employ a single fan or more than two fans.

Of note, in embodiments where a fluid other than air is used for cooling, the fan housing 40 may instead be replaced with a pump housing that is integrally formed in the cell retainer assembly 30 and the fan 42 may be replaced by a pump. Furthermore, although many embodiments of the thermal management system are described here as being used for preventing overheating of the battery pack 10, some embodiments could be used similarly for heating a battery pack where the battery pack is used in an extremely cold environment. Instead of blowing air from the environment through the cell retainer assembly 30, heated air could be blown through the cell retainer assembly to warm the battery pack 10 above a predefined minimum threshold temperature. Accordingly, for example, fluid flow may be employed for either heating or cooling of the battery pack 10 to maintain desirable temperatures. In some cases, temperature may be maintained between T=0° C. and T=45° C. for charging, and between T=−10° C. and T=65° C. for discharging, since battery performance may be considered to be optimal within those respective ranges.

Referring again to the figures, the fan 42 (or fans) may be powered from the battery pack 10 or from its own smaller electrical source (e.g., a smaller rechargeable or replaceable battery). Operation of the fan 42 may push air through cell retainer assembly 30 to cool the cells 20. In some embodiments, control circuitry may be provided for control of the fan 42. The control circuitry may be in communication with a temperature sensor to initiate fan 42 operation at a predetermined threshold temperature (or secure fan 42 operation when below a particular temperature). In some embodiments, the control circuitry may further be enabled to secure operation of the fan and/or the device powered by the battery pack 10 responsive to temperatures reaching levels that are considered too high for operation of the device. Moreover, the control circuitry may prevent device operation if, for some reason, the fan 42 fails to operate when temperatures requiring fan operation are reached. In other embodiments, the control circuitry may control the fan at least in part based on whether the battery pack 10 is being charged or discharged. For example, the control circuitry may always operate the fans while the battery pack 10 is being charged or discharged. When the operator stops charging or discharging the battery pack, the control circuitry may then run the fan for a preset amount of time thereafter and/or may communicate with a temperature sensor and operate the fan until the temperature of the battery pack falls below a threshold temperature.

In an example embodiment, the cell retainer assembly 30 may include an inlet air guide 50 that is disposed at an outlet of the fan 42 (or fans) to guide air into channels that are defined between some of the cells 20 as described in greater detail below. As such, the fan 42 may be configured to push air linearly through the cell retainer assembly 30 via the inlet air guide 50. In the illustrated embodiment, in order to keep a relatively thin profile for the battery pack 10, the fans 42 have a diameter approximately equal to the longitudinal length of a cell 20 so that the fans 42 do not significantly add thickness to the battery pack 10. However, since the battery pack 10 is wider than the twice the diameter of the fan 42, the inlet air guide 50 includes a diffuser that is configured so that the airflow exiting the fan is spread outward to either side of the fan to create an appropriate flow of air throughout the cell retainer assembly 30. In other embodiments, one fan or more than two fans may be used with larger or smaller diffusers in the air inlet guides 50.

In some cases, the air may enter the cell retainer assembly 30 in a first direction (e.g., the y-direction) and be pushed past all of the cells 20 while substantially maintaining the first direction. After passing by all of the cells 20, the air may exit the cell retainer assembly 30 via outlet air guides 52 in a second direction (e.g., the x-direction) that is substantially perpendicular to the first direction. However, in some embodiments, the air may exit the cell retainer assembly 30 also in the first direction. Regardless of how the air enters or exits the portion of the cell retainer assembly 30 in which the cells 20 are housed, the air within the portion of the cell retainer assembly 30 in which the cells 20 are housed may substantially maintain only one direction while passing therethrough. Moreover, the cell retainer assembly 30 may provide for the inlet, outlet and channel fluid paths to be defined entirely between two planes defined by the top and bottom of the top part 32 and bottom part 34, respectively.

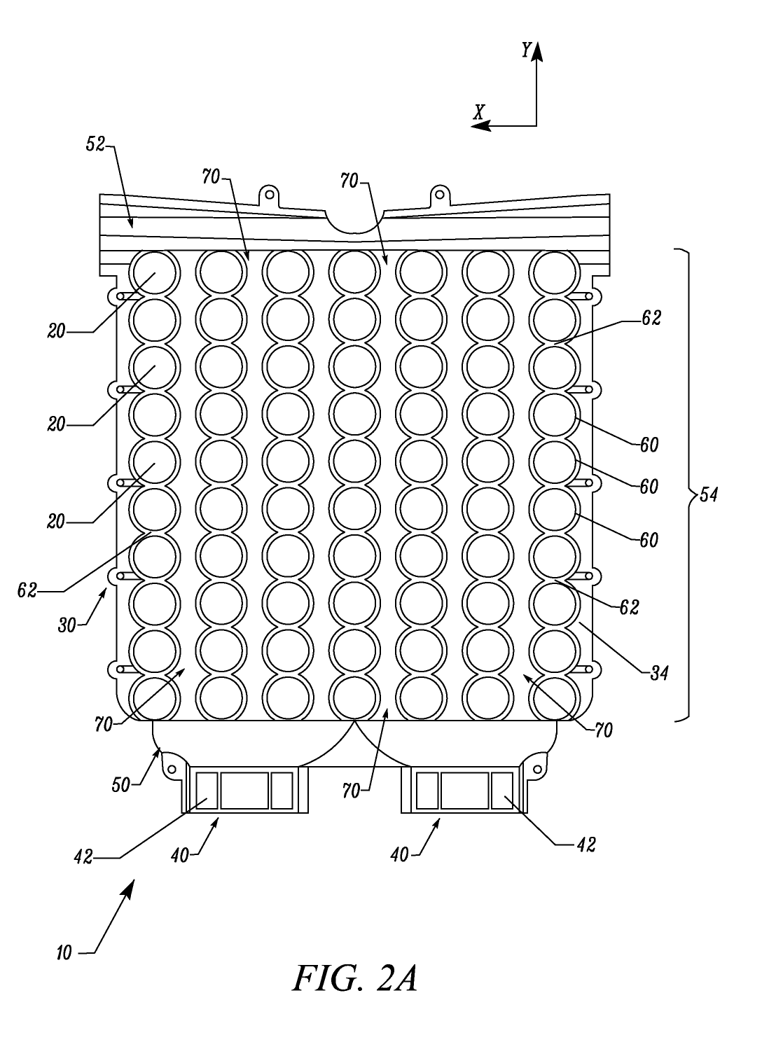

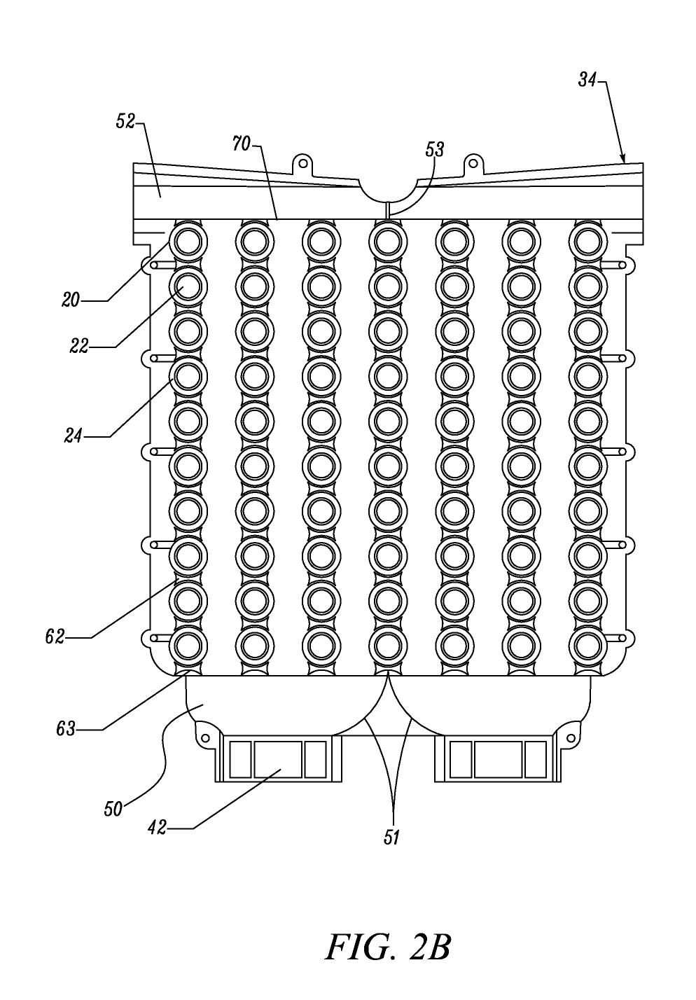

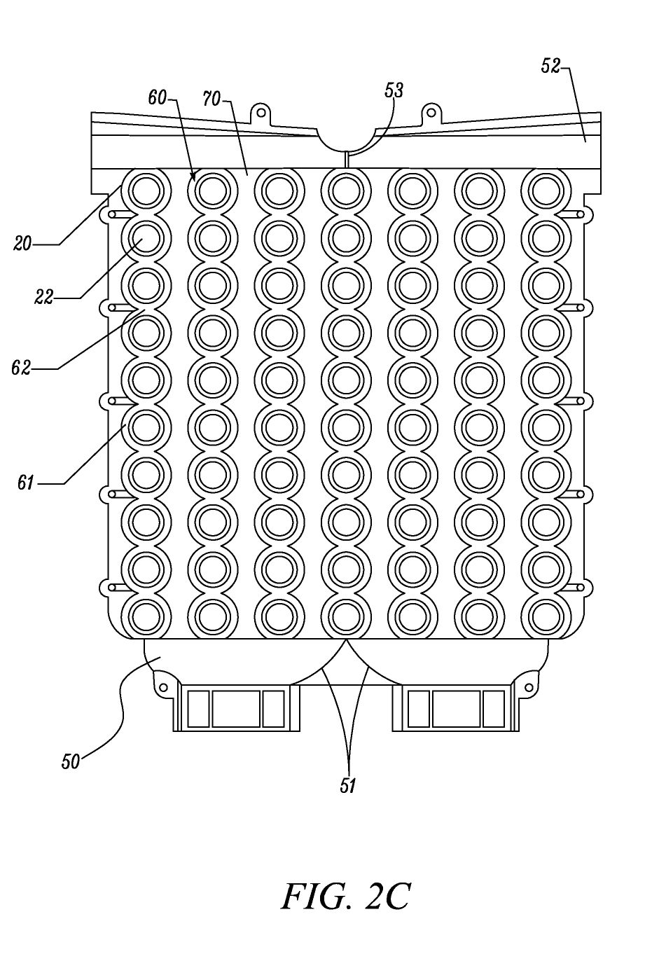

FIG. 2A illustrates a top view of the battery pack 10 with the top part 32 removed in order to reveal the inner structure of the cell retainer assembly 30 of an example embodiment. Of note, the battery pack 10 in FIG. 2A has ten cells per column and seven cells per row rows to illustrate the fact that any number of cells may be supported by example embodiments. As can be appreciated from the view shown in FIG. 2A, the cells 20 may be disposed within the cell retainer assembly 30 such that a longitudinal length of the cells extends substantially perpendicular to a direction of the flow of air through the cell retainer assembly 30. As shown in FIG. 2A, the cells 20 may be held within the cell retainer assembly 30 in cell reception slots 60. In some embodiments, the walls of the cell reception slots 60 may be made from a material that has a high thermal conductivity (e.g., metal or thermally conductive plastic) to enable heat to be readily dissipated or transmitted away from the cells 20 so that air forced into the inlet air guide 50 may pass by the cell reception slots 60 (or portions thereof) to carry heat away from the cells 20 while the air passes to the outlet air guide 52. In some embodiments, the cell reception slots 60 are integrally formed in the cell retainer assembly 30 and are, therefore, made of the same material as the cell retainer assembly 30.

As illustrated in FIGS. 1B-3, the cell retainer assembly 30 generally includes a plurality of ribs 62. As used herein, a rib 62 generally refers to material disposed between adjacent cell reception slots (i.e., between adjacent cells) to inhibit air from flowing in the space between the adjacent cells/cell reception slots. In the embodiments illustrated by the figures, the cell retainer assembly 30 includes ribs 62 between adjacent cells in each column of cells that inhibit air from flowing through the space between adjacent cells in a column. In this way, airflow channels 70 are created between adjacent cell columns, where the airflow channels 70 extend from an inlet air guide 50 to an outlet air guide 52, and where air in one airflow channel 70 is substantially prevented from flowing into another airflow channel 70. It will be appreciated that, although the embodiments illustrated in the figures show ribs 62 between adjacent cells in a column and airflow channels 70 created between adjacent columns, other embodiments could instead have ribs between adjacent cells in each row that create airflow channels between adjacent rows. Likewise, although the embodiments illustrated in the figures show ribs 62 between adjacent series-connected cells and airflow channels 70 created between adjacent columns of series-connected cells, in other embodiments the orientation of the cells could be altered to where the ribs are located between adjacent parallel-connected cells to create airflow channels between adjacent columns of parallel-connected cells.

In some embodiments, the ribs 62 may be disposed on substantially opposite sides (e.g., about 180° apart relative to the periphery of the cell reception slots 60 that have adjacent slots on each side) of each of the cells in a column (or row) such that the cell reception slots 60 of each respective column (or row) define a continuous wall that extends from a point where air leaves the inlet air guides 50 to a point where air enters the outlet air guides 52.

In other words, the cell housing portion 54 of the cell retainer assembly 30 may provide walls formed between adjacent cells (e.g., cells in a same column that are series connected to each other) by the placement of ribs 62 that are positioned 180° apart from each other relative to the circumference of the cell reception slots 60. These walls may be substantially parallel to each other extending from inlet to outlet of the cell housing portion 54. These ribs 62 combine with sidewalls of the cell reception slots 60 or the sidewalls of the cells 20 disposed therein to form continuous walls that define parallel fluid flow channels (e.g., airflow channels 70) in the cell housing portion 54 of the cell retainer assembly 30. In an example embodiment, one airflow channel 70 may be defined between each of the adjacent columns of cells. Moreover, as can be appreciated from FIG. 2, the airflow channel 70 may characteristically pass substantially linearly through the cell housing portion 54 and may extend substantially parallel to each other from inlet to outlet of the cell housing portion 54. As such, the continuous walls formed may cut off any cross-flow channels that would otherwise exist to allow airflow between adjacent cells in the same column. Accordingly, the airflow channels 70 are formed between sides of adjacent cells such that air flows substantially in a single direction (e.g., the y-direction in FIGS. 1 and 2) as it passes by the sides of the adjacent cells through the cell housing portion 54 in order to prevent cross-flow between at least some cells where the cross-flow would be in another direction (e.g., in the x-direction in FIGS. 1 and 2).

It should also be appreciated that some minor components of the overall airflow through the airflow channels 70 may be in other directions. For example, some small eddy currents or other turbulent flow components may exist. However, generally speaking, these will be minor components and rather negligible. Although fully laminar flow through the airflow channels 70 may not be provided, the overall direction of flow through the cell housing portion 54 will be in a single direction and cross-flow (or just airflow in general) will be prevented between at least two adjacent cells (e.g., series connected cells or cells in the same column). In the illustrated embodiment, the single direction is a direction that is substantially perpendicular to the longitudinal length of the cells 20.

FIG. 2A illustrates a top view of the battery pack with a top part removed in order to reveal the inner structure of a cell retainer assembly of an example embodiment shown with battery cells disposed within cell reception slots. FIG. 2B also illustrates a top view of the battery pack with a top part removed, but also shows the battery pack with the battery cells removed from cell reception slots to better illustrate the structure of the cell retainer assembly according to an example embodiment. In the example embodiment illustrated in FIGS. 1B, 2A, and 2B the ribs 62 at least partially define the cell reception slots 60. Specifically, in this embodiment the ribs 62 between adjacent cell reception slots 60 in each column and end ribs 63 at the end of each column extend perpendicularly from the walls of the bottom part 34 and top part 32 and function to help hold the cells 20 in place in the cell retainer assembly 30. In this embodiment the cell reception slots 60 are otherwise open between the ribs. In this way, when a cell 20 is inserted into a cell reception slot 60, a portion of the cell sidewall is exposed to the air in the adjacent airflow channel(s) 70. However, the cell 20 may fit tightly or closely with the adjacent ribs to that the cell sidewall combines with the adjacent ribs to define a continuous wall of the airflow channel(s) 70 and inhibits air from one airflow channel flowing into another airflow channel.

FIG. 2B also further illustrates holes 22 in the bottom part 34 at one end of each cell reception slot 60. As described above, these holes 22 allow each cell to electrically connect with connectors located on the outside of the cell retainer assembly 30. The holes 22 may have a smaller diameter than that of a cell so that cell and the wall of the cell retainer assembly 30 come together to inhibit air flowing through the interior of the cell retainer assembly 30 from flowing through the holes 22. A gasket, resilient member, or other seal 24 may be located around each hole 22 to further prevent air, moisture, or debris from leaking through the hole and contaminating the electrical connections and/or components located on the exterior of the cell retainer assembly. Similar holes 22 and, in some embodiments, seals 24 are also located in the top part 32 for allowing an electrical connection to be made to the other end of the cell while isolating the electrical connection(s) and/or components from the air flowing through the interior of the cell retainer assembly. In this regard, it should be appreciated that embodiments of the battery pack 10 described herein may be particularly advantageous for use in dirty, dusty, or moist environments (e.g., such as those often experienced when using outdoor power equipment or construction equipment) because the intelligent design serves to control the temperature of the battery pack 10 by blowing air from the battery pack's environment through the battery pack 10, but at the same time substantially prevents the air that's blown through the battery pack 10, which may carry moisture, dust, dirt, and other debris from then environment, from contaminating many of the electrical components of the battery pack 10.

In another example embodiment illustrated in FIG. 2C, the cell reception slots 60 may be at least partially defined by slot walls 61 that completely or substantially surround sidewalls of the cells 20. As such, for example, the cell reception slots 60 may include walls 61 that surround radial edges of the cells 20 over substantially all of the longitudinal length of the cells 20 when the top part 32 and bottom part 34 are joined together, thereby encasing the cell. Moreover, in some cases, the cell reception slots 60 may be positioned relative to one another such that at least some sidewall portions defining the cell reception slots 60 are in direct contact with, shared with, or essentially part of, corresponding sidewall portions of adjacent cell reception slots.

Such intersections between cell reception slots 60 are still referred to herein as ribs 62. In the example of FIG. 2C, the ribs 62 are formed by the intersection (or direct connection) of slot walls 61. However, in other embodiments, the ribs 62 could be formed by the insertion of material between the slot walls 61 of adjacent cell reception slots 60 in order to prevent airflow between the cell reception slots 60 joined by the respective ribs 62. The material used to form the slot walls 61 and the ribs 62 may be thermally conductive material. However, the ribs 62 could be formed of any material sufficient to prevent cross-flows from one airflow channel to another in the area between the corresponding joined cells.

FIGS. 2A-2C also illustrate how, in some embodiments, the walls 51 of the inlet air guide 50 may be configured to meet with the cell 20, slot wall 61, or end rib 63 at the end of the column located halfway between the fans 42 to prevent cross-flow of air from the inlet air guide 50 of one fan to the inlet air guide 50 of another fan. Likewise, a wall 53 in the outlet air guide 52 may be configured to meet with the cell 20, slot wall 61, or end rib 63 at the end of the column located halfway between the outlets to prevent cross-flow of air between the two outlet channels. The figures also illustrate how embodiments of the outlet air guide 52 includes two channels taking air to either side of the battery pack and how these channels expand as they get closer to the outlets on the sides of the battery pack. This expansion may help to keep a uniform unobstructed airflow from the airflow channels 70 into the outlet channel and then through the outlet channel in the direction of the side outlets since the outlet channel must handle a greater volume of air as it gets closer to the side outlets due to the additional air being added by each successive airflow channel 70.

FIG. 1B illustrates one embodiment where the ribs and other walls of the cell retainer assembly are formed by ribs and walls of the bottom part 34 meeting with corresponding ribs and walls of the top part 32 to form the complete ribs and other walls. However, it will be understood that in other alternative embodiments the ribs and/or other walls may extend to their full heights from either the top part 32 or the bottom part 34.

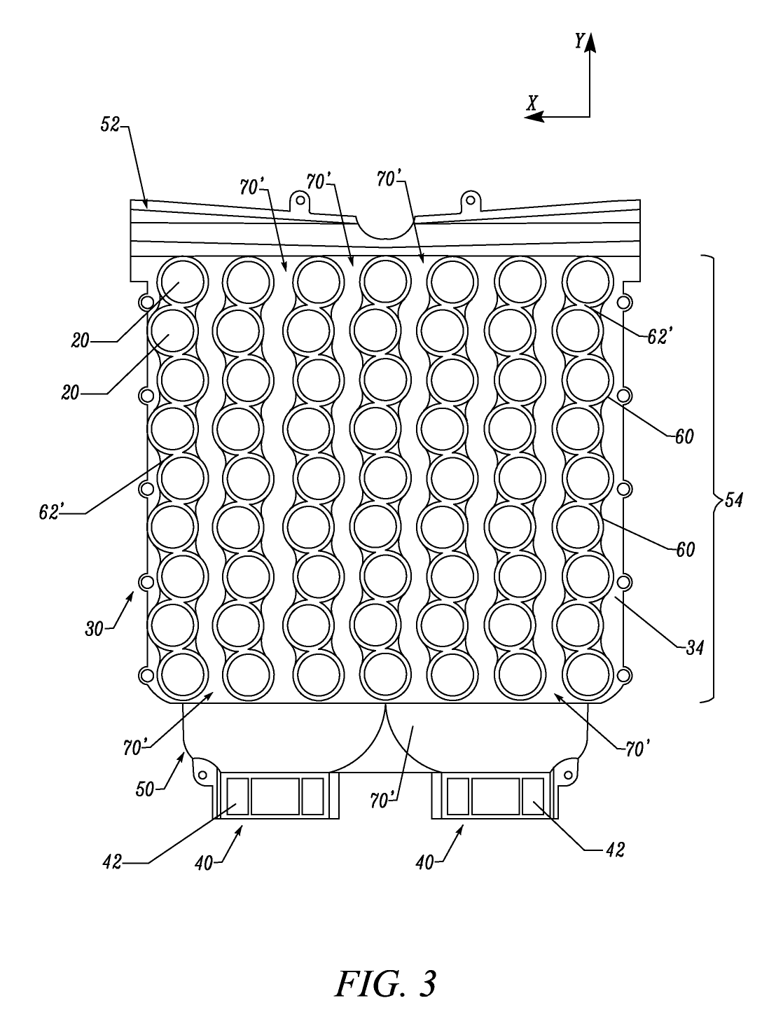

In the examples of FIGS. 1-2C, the airflow channels 70 may be essentially straight. However, some minor curvature may be accommodated in some example embodiments. For example, FIG. 3 shows an embodiment where airflow channels 70′ are formed that have a slightly wavy shape as airflow passes through the cell housing portion 54. The structure of FIG. 3 may be achieved by offsetting alternating cells in each column slightly and moving the ribs 62′ to portions of the cell reception slots 60 that are not directly opposite of each other of relative to the cells 20. Thus, whereas placing the ribs 62 on opposite sides of cells 20 in the same column in FIG. 2 cause a substantially linear flow through the cell housing portion 54 to remove heat from the cells 20, placing each subsequent one of the ribs 62′ less than 180 degrees away from a preceding rib, the embodiment of FIG. 3 creates a wavy flow path through the cell housing portion 54. However, in this example embodiment as well, cross-flow is prevented between at least two adjacent cells (e.g., series connected cells or cells in the same column), while the overall direction of flow continues to be in a single direction (e.g., a direction substantially perpendicular to the longitudinal length of the cells 20). The prevention of cross airflow between channels that is provided by employment of the ribs between the cells may cause a lower flow resistance within the battery pack 10. Accordingly, a lower pressure may be employed for driving the same level of flow through the battery pack 10. Achieving a lower driving pressure may mean that relatively common or standard axial fans may be used in some designs, and thus a large battery pack can be cooled with relatively low cost fans. Of note, however, some special instances may benefit from the removal of one or more ribs to allow a small amount of cross flow in certain areas. This type of modification may be used in limited circumstances to avoid significant increases in driving pressure while allowing flow to provide additional cooling to some areas that may be hot spots.

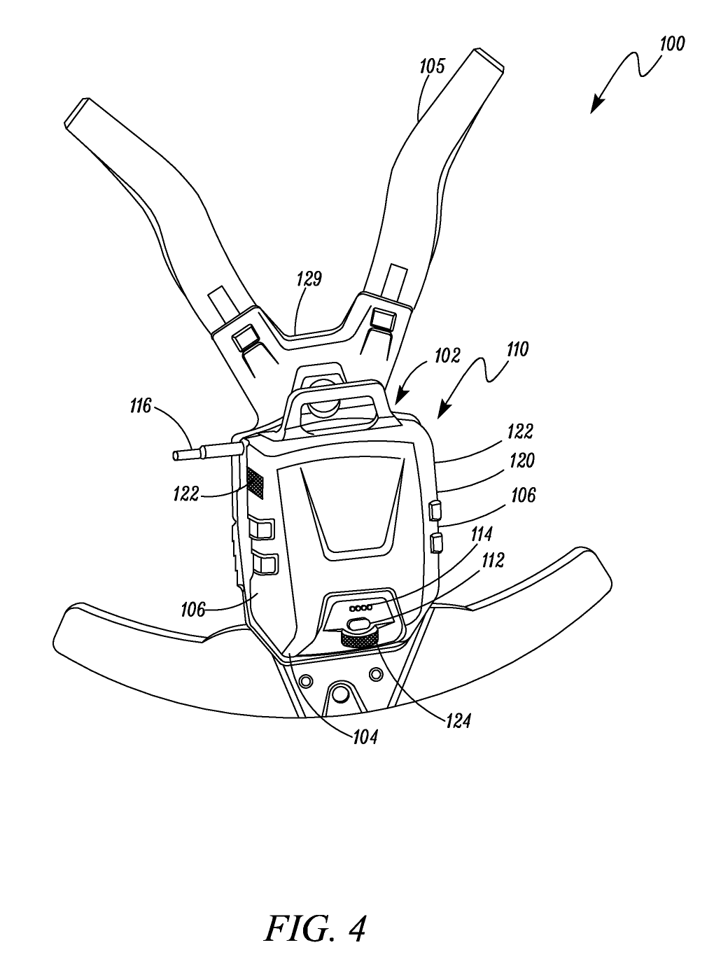

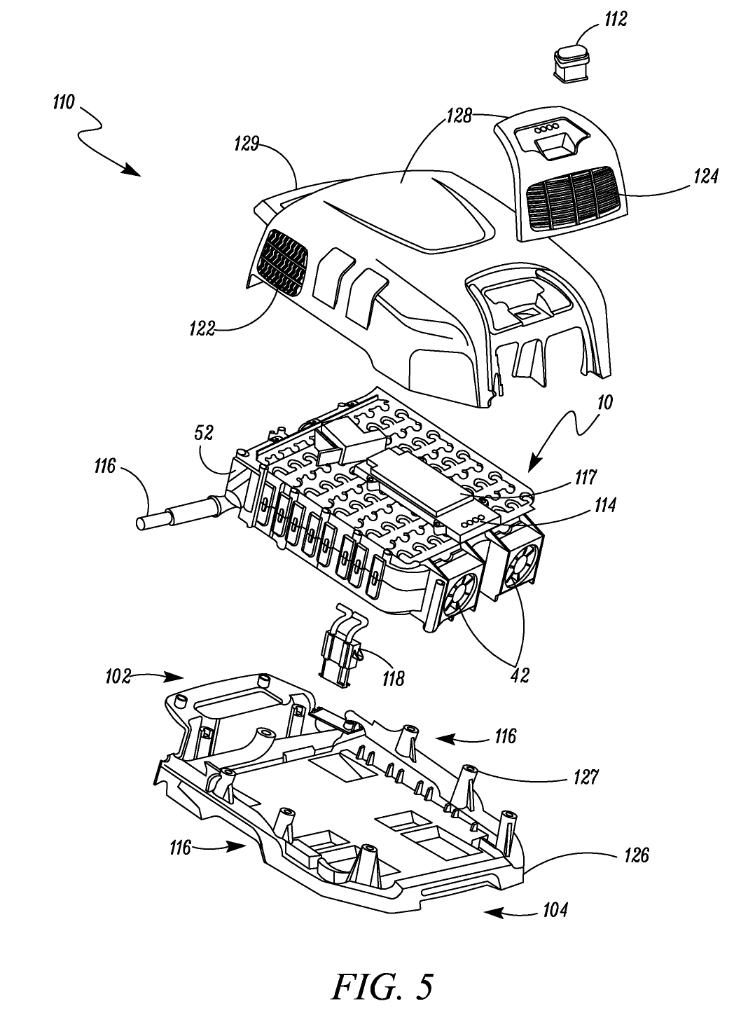

FIG. 4 illustrates the battery pack 10 incorporated into a backpack battery 100 in accordance with an example embodiment, and FIG. 5 illustrates a partially exploded view of the backpack battery pack 110 according to an example embodiment. The backpack battery 100 is a battery pack configured to be worn on the user's back during operation. In an example embodiment, the backpack battery pack 110 may affixed to straps 105 or another harness that may be usable to attach the backpack battery 100 to the user's back. In some cases, the backpack battery pack 110 may be oriented such that an upper end 102 thereof is oriented upward and a lower end 104 thereof is oriented downward. The backpack battery pack 110 may also have sidewalls 106 that extend between the upper end 102 and the lower end 104 along sides of the backpack battery pack 110. The sidewalls 106 may form part of a battery pack housing 120, which may form a rigid casing or housing around the battery pack 10.

In an example embodiment, the battery pack 10 may be oriented such that the fans 42 are proximate to the lower end 104 of the backpack battery pack 110. Accordingly, for example, an inlet screen 124 through which incoming air may be drawn may also be disposed at the lower end 104 of the backpack battery pack 110. Moreover, in some embodiments, the inlet screen 124 may be disposed such that it is oriented downward when the backpack battery pack 110 is worn on the user's back so that incoming air is drawn upward and the fans 42 are less exposed to the elements (e.g., rain and falling debris). Air is therefore passed through channels (e.g., airflow channels 70) that are oriented vertically when worn on the user's back. Moreover, the inlet and the airflow channels may both be aligned vertically, while the outlet of the air is oriented horizontally.

In this regard, for example, after the air is passed through the battery pack 10 as described above, the air may be rejected out of an outlet screen 122 that may be disposed in portions of the sidewalls 106 that are proximate to the upper end 102. Since the outlet screen 122 is oriented to the side of the backpack battery pack 110, again rain, falling debris and/or other potential contaminants may be inhibited from entering the battery pack housing 120. In some cases, two outlet screens 122 may be provided such that they allow air to exit the backpack battery pack 110 in opposite directions to distribute ejected air behind and away from the user. The placement of the inlet screen 122 and outlet screen 124 also enables the battery pack 10 to be shielded by the user's body at least in part from debris or other environmental materials that may be stirred via operation of the equipment powered by the battery pack 10 since such equipment powered by the battery pack 10 is typically utilized in front of the user.

In an example embodiment, the backpack battery pack 110 may further include a start button 112 disposed at a portion of a top cover 128 of the battery pack housing 120. LED lights 114 may also be provided to indicate an operational state of the backpack battery pack 110 and/or provide information about thermal properties of the backpack battery pack 110. The cell retainer of the battery pack 10 may be disposed below the top cover 128 of the battery pack housing 120 and may be mated with a bottom cover 126. As such, the cell retainer may be completely enclosed between the bottom cover 126 and the top cover 128. Connectors 127 may be provided at various locations in order to facilitate fixing the bottom cover 126 to the top cover 128. In some embodiments, a handle 129 may be provided at the upper end 102 of the battery pack housing 120 to enable the user to carry the backpack battery pack 110 when it is not strapped to the user's back. In an example embodiment, seals may be provided proximate to the inlet screen 124 (or the outlet screen 122) between the battery pack housing 120 and the cell retainer to further inhibit the entry of air, moisture and debris between the battery pack housing 120 and cell retainer.

In some embodiments, one or more fuse elements 118 may be provided between the battery pack 10 and the equipment that is powered thereby. Moreover, a PCB 117 may be provided with control circuitry that may be used to control the application of electrical power from the battery pack 10.

As can be appreciated from the example embodiments above, some embodiments may provide a battery pack including a cell housing and a plurality of cell reception slots disposed therein. The cell housing may be configured to retain a plurality of battery cells. The plurality of cell reception slots may be disposed within the cell housing to receive respective ones of the battery cells. The cell reception slots may be disposed within the cell housing to define at least one fluid flow channel extending substantially in a first direction through the cell housing. The fluid flow channel may be defined at least partially by a rib connecting at least two adjacent cell reception slots to enable heat removal from cells disposed in the at least two adjacent cell reception slots responsive to movement of a fluid through the fluid flow channel and to prevent a cross-flow of fluid between the at least two adjacent cell reception slots in a direction other than the first direction.

In some cases, modifications or amplifications may further be employed including (1), the cell reception slots may be disposed in a same plane to hold the cells such that a longitudinal centerline of each one of the cells is parallel to a longitudinal centerline of other ones of the cells. The cell reception slots may be disposed in at least two columns within the cell housing such that the cell reception slots of each cell in a same column are directly connected to each other by respective ribs to form respective sidewalls of the fluid flow channel. In an example embodiment (2), the ribs may be formed on substantially opposite sides of the cell reception slots to form a substantially straight flowpath through the fluid flow channel or may be formed (3) less than 180 degrees away from each other on opposing sides of the cell reception slots to form a substantially wavy flowpath through the fluid flow channel.

In an example embodiment, none, any or all of modifications/amplifications (1) to (3) may be employed and the first direction may be substantially perpendicular to a longitudinal centerline of the cell reception slots, or the first direction may be substantially parallel to a longitudinal centerline of the cell reception slots. In some cases, none, any or all of modifications/amplifications (1) to (3) may be employed and the battery pack may further include a fan configured to operate to force air through the fluid flow channel. In an example embodiment, none, any or all of modifications/amplifications (1) to (3) may be employed and the cell housing forms a portion of a cell retainer assembly, where the cell retainer assembly includes a top part forming substantially a top half of the cell retainer assembly and a bottom part forming substantially a bottom half of the cell retainer assembly. The top part and bottom parts fit together to form the cell retainer assembly, and the cell retainer assembly defines the cell housing, an inlet flow guide distributing air into a plurality of fluid flow channels in the first direction and an outlet flow guide for directing air exiting from the fluid flow channels to a second direction that is substantially perpendicular to the first direction. In some embodiments, none, any or all of modifications/amplifications (1) to (3) may be employed and the cell housing forms a portion of a cell retainer assembly. The cell retainer assembly may further include a fan housing integrally formed as a portion of the cell retainer assembly. In some cases, such as any of those described above, the battery pack may be provided in a backpack of a battery powered outdoor power equipment device.

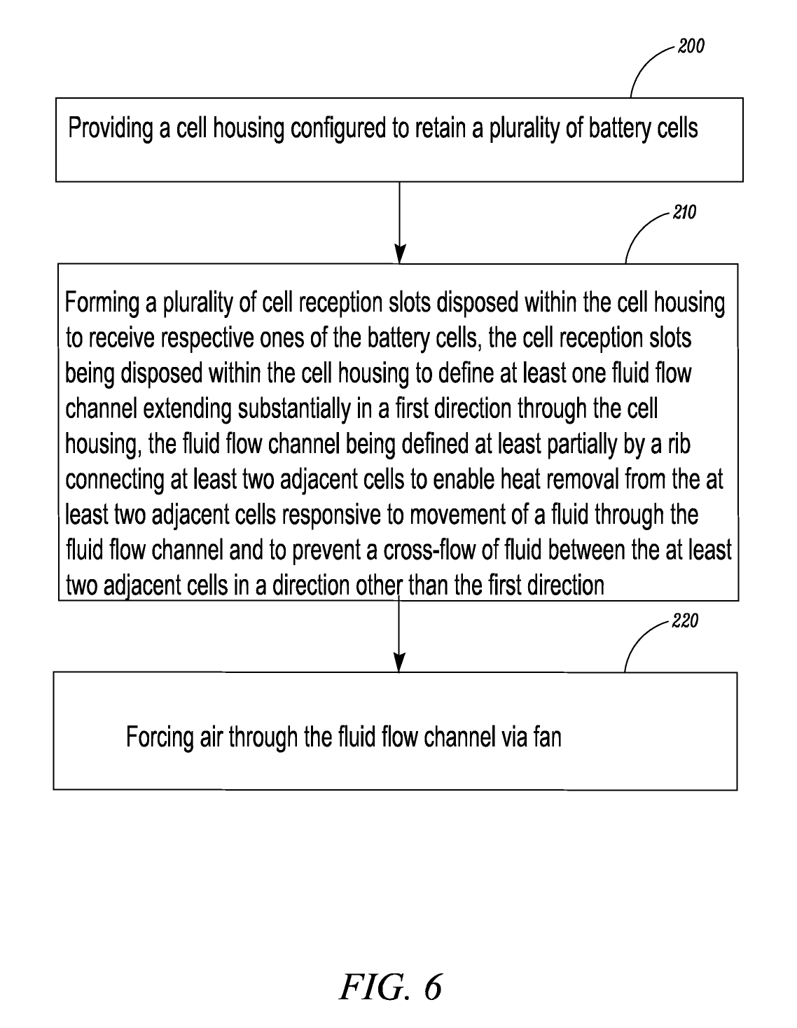

FIG. 6 illustrates a method of thermally managing a battery pack in accordance with an example embodiment. It should be appreciated that some embodiments of the invention may make cooling a battery pack easier when several cells or groups of cells need to be employed. In this regard, a method of providing cooling to a battery pack may include providing a cell housing configured to retain a plurality of battery cells at operation 200 and forming a plurality of cell reception slots disposed within the cell housing to receive respective ones of the battery cells at operation 210. The cell reception slots may be disposed within the cell housing to define at least one fluid flow channel extending substantially in a first direction through the cell housing The fluid flow channel may be defined at least partially by a rib connecting at least two adjacent cell reception slots to enable heat removal from cells disposed in the at least two adjacent cell reception slots responsive to movement of a fluid through the fluid flow channel and to prevent a cross-flow of fluid between the at least two adjacent cell reception slots in a direction other than the first direction.

In some embodiments, the operations above may be modified or amplified, and/or additional operations may be included in the method. For example, in some cases, the method may further include forcing air through the fluid flow channel via a fan at operation 220. In some embodiments, forming the plurality of cell reception slots may include forming each subsequent rib substantially 180 degrees apart from each previous rib relative to a periphery of the cell reception slots or forming each subsequent rib less than 180 degrees apart from each previous rib relative to a periphery of the cell reception slots. In an example embodiment, any or all of the modifications discussed above may be provided and forming the cell reception slots may include forming the cell reception slots within a cell retainer that includes a top part forming substantially a top half of the cell retainer assembly and a bottom part forming substantially a bottom half of the cell retainer assembly. The top part and bottom parts may fit together to form the cell retainer assembly. The cell retainer assembly may define the cell housing, an inlet flow guide distributing air into a plurality of fluid flow channels in the first direction and an outlet flow guide for directing air exiting from the fluid flow channels to a second direction that is substantially perpendicular to the first direction.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A battery pack comprising:
a cell housing configured to retain a plurality of battery cells; and
a plurality of cell reception slots within the cell housing to receive respective ones of the battery cells, the cell reception slots being configured within the cell housing to define at least one fluid flow channel extending substantially in a first direction through the cell housing, the fluid flow channel being defined at least partially by a rib connecting at least two adjacent cell reception slots to enable thermal transfer from cells disposed in the at least two adjacent cell reception slots responsive to movement of a fluid through the fluid flow channel and to inhibit a cross-flow of fluid between the at least two adjacent cell reception slots in a direction other than the first direction.

2. The battery pack of claim 1, wherein the fluid flow channel is configured such that the fluid will move through the fluid flow channel substantially perpendicular to a longitudinal axis of the cells.

3. The battery pack of claim 1, wherein the cell reception slots are disposed in a same plane to hold the cells such that a longitudinal centerline of each one of the cells is parallel to a longitudinal centerline of other ones of the cells, the cell reception slots being disposed in at least two columns within the cell housing such that the cell reception slots of each cell in a same column are directly connected to each other by respective ribs to form respective sidewalls of the fluid flow channel.

4. The battery pack of claim 3, wherein the ribs are formed on substantially opposite sides of the cell reception slots to form a substantially straight flowpath through the fluid flow channel.

5. The battery pack of claim 3, wherein the ribs are formed less than 180 degrees away from each other on opposing sides of the cell reception slots to form a substantially wavy flowpath through the fluid flow channel.

6. The battery pack of claim 1, wherein the first direction defines an airflow direction that is substantially perpendicular to a longitudinal centerline of the cell reception slots.

7. The battery pack of claim 1, further comprising a fan configured to operate to force air through the fluid flow channel.

8. The battery pack of claim 1, wherein the cell housing forms a portion of a cell retainer assembly, the cell retainer assembly including:
a top part forming substantially a top half of the cell retainer assembly; and a bottom part forming substantially a bottom half of the cell retainer assembly, the top part and bottom part fitting together to form the cell retainer assembly, and
wherein the cell retainer assembly defines the cell housing, an inlet flow guide distributing air into a plurality of fluid flow channels in the first direction and an outlet flow guide for directing air exiting from the fluid flow channels to a second direction that is substantially perpendicular to the first direction.

9. The battery pack of claim 1, wherein the cell housing forms a portion of a cell retainer assembly, the cell retainer assembly including a fan housing integrally formed as a portion of the cell retainer assembly.

10. The battery pack of claim 1, wherein the battery pack is provided in a backpack of a battery powered outdoor power equipment device.

11. The battery pack of claim 1, wherein the cell retainer assembly overlaps opposing longitudinal ends of the battery cells and includes a seal proximate to each longitudinal end to seal a space between the respective longitudinal ends of the battery cells and the cell retainer assembly.

12. The battery pack of claim 1, wherein the fluid flow channels are separated from electrical circuitry of the battery pack,
wherein the ribs are integrally formed as part of the cell retainer assembly, or
wherein the ribs or the cell retainer assembly are formed of a thermally conductive material.

13. (canceled)

14. (canceled)

15. The battery pack of claim 1, wherein the first direction is oriented to ascend vertically when the battery pack is worn on the back of a user.

16. The battery pack of claim 15, wherein an inlet of the fluid flow channel is oriented downward proximate to a bottom end of the battery pack, and at least one outlet of the fluid flow channel is oriented horizontally at a top end of the battery pack.

17. The battery pack of claim 1, wherein n columns of battery cells and m rows of battery cells are provided in the battery pack and wherein n−1 fluid flow channels are provided therebetween.

18. The battery pack of claim 17, wherein an additional fluid flow channel is provided outside a first column and a last column to provide n+1 total fluid flow channels.

19. The battery pack of claim 17, wherein n is an odd number and m is an even number or wherein m is an odd number and n is an even number,
wherein m and n are both even numbers or wherein m and n are both odd numbers, or
wherein n is a value between three and nine and m is a value between four and ten.

20. (canceled)

21. (canceled)

22. A battery powered, outdoor power equipment device comprising:
a battery pack including a plurality of battery cells;
a cell retainer assembly including a cell housing configured to retain the battery cells; and
a plurality of cell reception slots within the cell housing to receive respective ones of the battery cells, the cell reception slots being configured within the cell housing to define at least one fluid flow channel extending substantially in a first direction through the cell housing, the fluid flow channel being defined at least partially by a rib connecting at least two adjacent cell reception slots to enable heat removal from cells disposed in the at least two adjacent cell reception slots responsive to movement of a fluid through the fluid flow channel and to inhibit a cross-flow of fluid between the at least two adjacent cell reception slots in a direction other than the first direction.

23. The device of claim 22, wherein the cell reception slots are disposed in a same plane to hold the cells such that a longitudinal centerline of each one of the cells is parallel to a longitudinal centerline of other ones of the cells, the cell reception slots being disposed in at least two columns within the cell housing such that the cell reception slots of each cell in a same column are directly connected to each other by respective ribs to form respective sidewalls of the fluid flow channel.

24-30. (canceled)

31. A method of cooling a battery pack, the method comprising:
providing a cell housing configured to retain a plurality of battery cells; and forming a plurality of cell reception slots within the cell housing to receive respective ones of the battery cells, the cell reception slots being configured within the cell housing to define at least one fluid flow channel extending substantially in a first direction through the cell housing, the fluid flow channel being defined at least partially by a rib connecting at least two adjacent cell reception slots to enable thermal transfer from cells disposed in the at least two adjacent cell reception slots responsive to movement of a fluid through the fluid flow channel and to inhibit a cross-flow of fluid between the at least two adjacent cell reception slots in a direction other than the first direction.

32-35. (canceled)
